(19) United States
(12) Patent Application Publication
(10) Pub. No.: US 2003/0123882 A1
(43) Pub. Date: Jul. 3, 2003

(54) Method and apparatus for conditioning a transmission path for free-space optical wireless data communications

(76) Inventors: Hossein Izadpanah, Newburry Park, CA (US); Mehran Mokhtari, Thousand Oaks, CA (US)

Correspondence Address: CARY TOPE MCKAY, 23852 PACIFIC COAST HIGHWAY #311, MALIBU, CA, 90265, US

(21) Appl. No.: 10/274,004

(22) Filed: Oct. 17, 2002

Related U.S. Application Data
(60) Provisional application No. 60/330,258, filed on Oct. 17, 2001.
(60) Provisional application No. 60/330,341, filed on Oct. 17, 2001.

(51) Int. Cl. H04B 10/10

(52) U.S. Cl. 398/119; 398/131

(57) ABSTRACT

A method and apparatus for conditioning a wireless data communication path for the transmission of a signal wave are presented. The apparatus comprises a conditioning wave transmitter positioned to transmit a conditioning wave along at least a portion of the wireless data communication path. The conditioning wave forms a conditioning envelope about the data communication path. The wavelength of the conditioning wave is selected to remove undesirable particles from the wireless data communication path. As a result, the wireless data communication path is conditioned to provide for improved data communication. The conditioning wave may be transmitted co-, counter-, or bi-directionally with respect to the signal wave, and may form a second data channel.

### PRIORITY CLAIM

The present invention claims priority to provisional application No. 60/330,258, titled “Atmospheric Beam Degradation Mitigation Techniques for Free-Space Laser Communication Systems,” filed with the U.S. Patent and Trademark Office on Oct. 17, 2001 and provisional application No. 60/330,341, titled “Beyond Line of Sight Communications and Image Projection,” filed with the U.S. Patent and Trademark Office on Oct. 17, 2001.

### BACKGROUND

(1) Technical Field

The present invention relates to field of optical and radio communications. More specifically, the present invention relates to a mechanism for conditioning a transmission path for free-space optical wireless data communications in adverse weather conditions.

(2) Discussion

Free-space optical wireless (FSOW) links, for example, in the infrared (IR) portion of the spectrum, as well as some directed radio frequency (RF) links, suffer from very high absorption/attenuation/turbulence from water during foggy weather as well as from other molecules present in the atmosphere. As a result, the FSOW link budget requires an extreme power dynamic range to compensate for signal attenuation/degradation and power loss. Often, the available optical power does not have sufficient dynamic range, leading to a loss of signal and link failure.

It is therefore desirable to provide a path conditioning mechanism that can aid in reducing absorption/attenuation/turbulence and other degradation, temporal and spatial, from the transmission path.

### SUMMARY

The present invention provides an apparatus for conditioning a wireless data communication path for the transmission of a signal wave. The apparatus comprises a conditioning wave transmitter positioned to transmit a conditioning wave along at least a portion of the wireless data communication path. The conditioning wave forms a conditioning envelope thereabout. The conditioning wave is of a wavelength selected to remove or reduce undesirable particles from the wireless data communication path, so that the wireless data communication path is conditioned to provide for improved data communication.

In another aspect, the signal wave is transmitted in a direction, and the conditioning wave transmitter is positioned to transmit the conditioning wave co-directionally with respect to the signal wave.

In yet another aspect, the signal wave is transmitted in a direction, and the conditioning wave transmitter is positioned to transmit the conditioning wave counter-directionally with respect to the signal wave.

In a further aspect, conditioning wave transmitters are positioned to transmit conditioning waves both co-directionally and counter-directionally with respect to the signal wave.

In a still further aspect, the conditioning wave is pulsed. The pulse pattern may be selected from a group consisting of evenly spaced pulses and (pseudo) randomly spaced pulses. Additionally, the conditioning wave has a wavelength selected from radio-frequencies and optical wavelengths. In one aspect, the conditioning wave has a millimeter wavelength; in another, it has a microwave wavelength; and in yet another, it has an optical wavelength.

In another aspect, the invention includes a feedback channel for dynamically adjusting the transmission characteristics of the conditioning wave transmitter based on a received power level of the signal wave. The feedback channel may be selected from a group consisting of a wired feedback loop from a data receiver receiving the signal wave to the conditioning wave transmitter, and a feedback signal transmitter positioned at the data receiver for transmitting a gage signal from the data receiver to the conditioning wave transmitter, with the feedback signal having a wavelength having a degradation characteristic correlated with that of the signal wave to facilitate adjustments to the conditioning wave effectiveness of the transmitter to improve signal wave transmission conditioning.

In another aspect, the invention further includes a conditioning wave receiver, and the conditioning wave transmitter transmits a conditioning wave that is received by the conditioning wave receiver. The conditioning wave, in this case, includes data, so that the conditioning wave transmitter and the conditioning wave receiver act as a second additional data channel.

In yet another aspect, the conditioning wave transmitter rotates the conditioning wave about an axis formed by the signal wave to form a spiral conditioning envelope thereabout.

In a still further aspect, the invention comprises a method for conditioning a wireless data communication path for the transmission of a signal wave. The method comprises a step of transmitting a conditioning wave along at least a portion of the wireless data communication path to form a conditioning envelope thereabout, with the conditioning wave having a wavelength selected to remove undesirable particles from the wireless data communication path, thereby conditioning the wireless data communication path to provide for improved data communication.

In another aspect, the signal wave is transmitted in a direction, and in the transmitting step, the transmitter transmits the conditioning wave in a direction, with the direction of the conditioning wave being co-directional, counter-directional, or both co-directional and counter-directional with respect to the direction of the signal wave.

In a still further aspect, in the transmitting step, the conditioning wave is pulsed. The pulse pattern may be selected from a group consisting of evenly spaced pulses and randomly spaced pulses. Additionally, the conditioning wave has a wavelength selected from radio-frequencies and optical wavelengths. In different aspects, the conditioning wave has a millimeter wave wavelength, a microwave wavelength, or is an optical signal.

In another aspect, the invention further comprises a step of dynamically adjusting transmission characteristics of the conditioning wave transmitter based on a received power level of the signal wave. This step may be performed using a feedback channel selected from a group consisting of a wired feedback loop from a data receiver receiving the signal wave to the conditioning wave transmitter, and a feedback signal transmitter positioned at the data receiver for transmitting a gage signal from the data receiver to the conditioning wave transmitter, with the feedback signal having a wavelength having a degradation characteristic correlated with that of the signal wave to facilitate adjustments to the conditioning wave effectiveness of the transmitter to improve signal wave transmission conditioning.

In yet another aspect, the conditioning wave carries data to be received by a conditioning wave receiver, thereby providing a second additional data channel.

In a still further aspect, the method further comprises a step of rotating the conditioning wave about an axis formed by the signal wave to form a spiral conditioning envelope thereabout.

### BRIEF DESCRIPTION OF THE DRAWINGS

The objects, features and advantages of the present invention will be apparent from the following detailed descriptions of the various aspects of the invention in conjunction with reference to the following drawings.

FIG. 1 is an illustrative example of an aspect of the present invention, in which a conditioning wave is transmitted co-directionally with respect to a free-space optical signal wave;

FIG. 2 is an illustrative example of an aspect of the present invention, in which a conditioning wave is transmitted co-directionally with respect to a signal wave, and in which the conditioning wave is pulsed in time for temporal/spatial effect;

FIG. 3 is an illustrative example of an aspect of the present invention, in which a conditioning wave is transmitted both co- and counter-directionally with respect to a signal wave; and

FIG. 4 is an illustrative example of an aspect of the present invention, in which a conditioning wave, in the form of a laser, is transmitted co-directionally with respect to a signal wave.

### DETAILED DESCRIPTION

The present invention relates to field of optical and radio communications. More specifically, the present invention relates to a mechanism for conditioning, temporally and/or spatially, a “guided channel” transmission path for free-space optical wireless data communications in adverse weather conditions. The following description, taken in conjunction with the referenced drawings, is presented to enable one of ordinary skill in the art to make and use the invention and to incorporate it in the context of particular applications. Various modifications, as well as a variety of uses in different applications, will be readily apparent to those skilled in the art, and the general principles defined herein, may be applied to a wide range of aspects. Thus, the present invention is not intended to be limited to the aspects presented, but is to be accorded the widest scope consistent with the principles and novel features disclosed herein. Furthermore it should be noted that unless explicitly stated otherwise, the figures included herein are illustrated diagrammatically and without any specific scale, as they are provided as qualitative illustrations of the concept of the present invention.

In order to provide a working frame of reference, first a glossary of terms used in the description and claims is given as a central resource for the reader. Then, a discussion of the specific details of the invention is presented.

(1) Glossary

Before describing the specific details of the present invention, a centralized location is provided in which various terms used herein and in the claims are defined. The glossary provided is intended to provide the reader with a general understanding for the intended meaning of the terms, but is not intended to convey the entire scope of each term. Rather, the glossary is intended to supplement the rest of the specification in more accurately explaining the terms used.

Conditioning Envelope—The term “conditioning envelope,” as used herein indicates the volume over which the conditioning wave alters the propagation channel for low degradation (e.g., lowers the attenuation due to fog and/or other disruptive molecules). The conditioning envelope may extend for the entire length of, or a desired portion of, the signal wave. The conditioning envelope may be in the form of a cone or cylinder through which the signal wave passes, or it may be in the form of a tube surrounding the signal wave. In addition, multiple conditioning envelopes of the same or different frequencies (to eliminate a wider variety of degrading/interfering substances) may be transmitted co-directionally with, counter-directionally to, or bi-directionally along the path of the signal wave. The conditioning envelope generally refers to the volume in which the conditioning wave is effective for impacting the channel transmission for the signal waves. The actual volume over which the conditioning wave is transmitted may be larger.

Conditioning Wave—The term “conditioning wave,” as used herein indicates the type of energy used to heat/disperse/eliminate fog and/or other disruptive molecules from the volume of the conditioning envelope and to unify the channel for low signal degradation due to turbulence. The frequency (wavelength) of the conditioning channel is tuned to the atmospheric absorption line for thermal blooming. Non-limiting examples of conditioning waves include microwave, millimeter wave, and optical signals.

Optical—The term optical, as used herein refers to electromagnetic energy that can be manipulated by optical techniques, and is not intended to be limited to the visible spectrum. Thus, infrared and other non-visible parts of the spectrum are considered within the scope of the term as used.

Signal Wave—The “signal wave” is the data signal transmission, typically in the form of a laser (i.e., a narrowly focused signal). The signal wave is encompassed by the conditioning envelope along a path from the data signal wave source (transmitter) and the data signal wave receiver. It is desirable that the data signal wave and the conditioning wave be selected such that at least the portion of the data signal wave that is relevant for data transmission is contained within the conditioning envelope.

(2) Discussion

The present invention provides a technique for ensuring a high degree of availability for terrestrial, “all weather” (e.g., rain, fog, and snow) RF/optical wireless communication links suitable for wireless access, distribution, and backbone network interconnections. The approach presented provides “conditioned” channels which ensure low attenuation during times when weather conditions are sub-optimal (e.g., in foggy weather). The creation of the low attenuation/absorption conditioning envelope, or “waveguide,” in the air is achieved by co-, counter-, and/or bi-directional propagated conditioning waves (e.g., laser/microwave/mm-wave beam(s)). The conditioning wave is generated at a wavelength selected for high water absorption so that it heats the atmosphere as it travels through the air. The introduction of the localized heat by the conditioning wave along the signal wave causes a temperature gradient and “burns off” the regional/local humidity, activating a convection effect, thereby transforming the channel within the area of the conditioning envelope into a low water-density region. In addition, the density of other “interfering” gases such as nitrogen, oxygen, etc. may also be decreased along the conditioning envelope by concurrently exposing the channel to beams of various wavelengths, in the absorption bands of the respective molecules. Through this procedure, a convection pattern will form, and will tend to create a region with low gas density during the data signal transmission. The actual formation of the conditioning envelope is caused by either constant or pulsed wave power. The co-/counterpropagation laser beam experiences lower absorption/attenuation, resulting in decreased channel attenuation and enhanced link availability. The increased wireless network reliability provides increased network aggregate capacity under all-weather, diverse atmospheric conditions, affording higher channel data rates (when compared to non-conditioned channels), and link fail/safe operation. Non-limiting examples of frequencies used for the conditioning wave include those for reducing fog (consisting of H₂O molecules), which has absorption bands within around 20 to 200 GHz, and for dispersing/eliminating O₂, which resonates at frequencies of about 60, 120, etc. GHz.

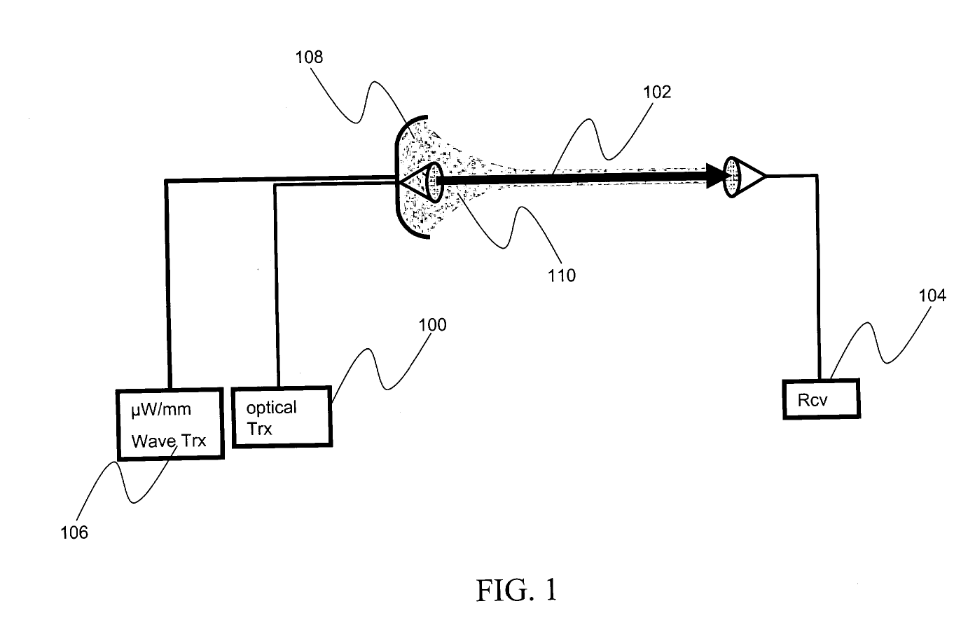

An illustrative diagram of an example of the present invention is shown in FIG. 1. In FIG. 1, a data transmitter 100 transmits a signal (data) wave 102 to be received by a data receiver 104. A conditioning wave transmitter 106 transmits a conditioning wave 108 such that it forms a conditioning envelope 110 about the signal wave 102. As mentioned in the glossary, the conditioning wave 108 can be of any useful wavelength, can be formed about the signal wave 102 in any desired pattern, can be continuous, pulsed with even or un-even intervals, and can be one-directional or bi-directional. Note that the conditioning envelope of FIG. 1 is shown as a continuous wave. In the case shown, the conditioning wave 108 is in the form of a microwave propagated from an antenna or antenna array to provide a gradual focusing characteristic along the path as its intensity decreases due to absorption. Due to the decay of the conditioning wave 108 power (e.g., the laser/microwave/mm-wave power) along the transmission length, it is desirable that the conditioning wave 108 beam be shaped to maintain a uniform power density over the desired length along the propagation path. Also, a spiral channel may be created by rotating the source of the conditioning wave 108 off its axis to create a protective conditioned channel.

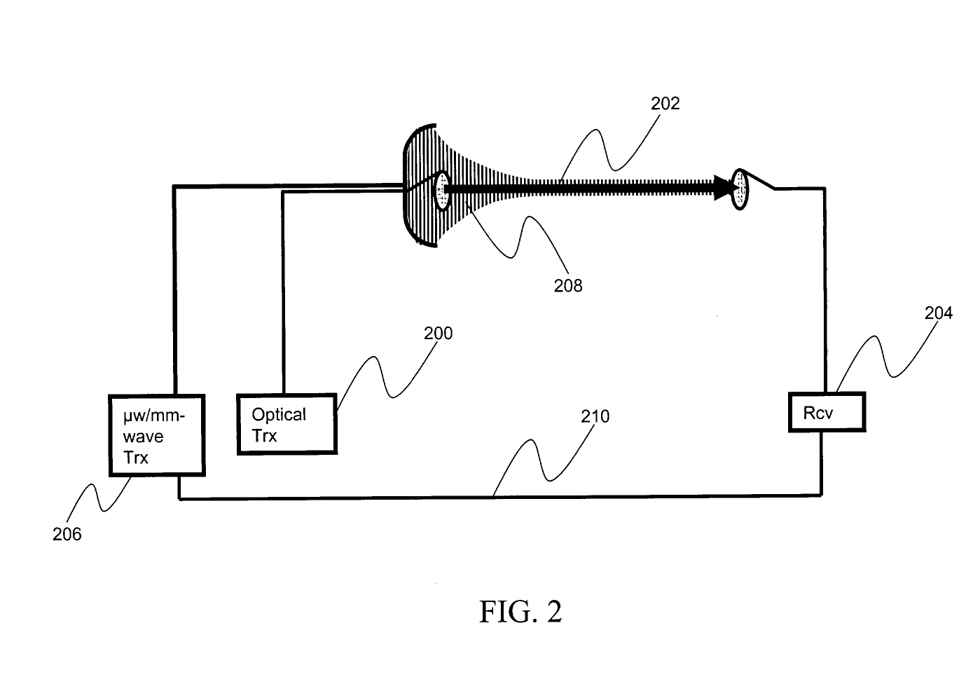

Another version of the present invention is presented in FIG. 2, which depicts a data transmitter 200 transmitting a signal wave 202 to be received by a data receiver 204. In this case, the conditioning wave transmitter 206 transmits a conditioning wave 208 in a pulsating manner. The pulsation technique is of use in cases where the nature of the conditioning wave transmitter 206 and the available power make a pulsating and bursty source desirable (e.g., for periodic/irregular spatial conditioning for different weather responses). The pulses may be provided in a periodic or pseudo-random manner. Also, a feedback channel 210 may be provided to help gauge the power level and/or pulse rate needed from the conditioning wave transmitter 206 to ensure a clear path for the signal wave 202. The feedback channel 210 may be in the form of a “hard-wired” feedback loop that provides feedback based on the power of the signal wave 202 as received at the data receiver 204, or it may be in the form of a wireless feedback wave transmitted in the reverse direction along the path of the signal wave 202, and received at the transmitter (in this case, the feedback wave is either of the same wavelength as the signal wave 202, or is of a wave that has a degradation characteristic correlated with that of the signal wave—e.g., a gage signal). The feedback channel 210 is used to adjust the transmission characteristics (e.g., signal power and possibly signal frequency) of the conditioning wave transmitter 206 in order to adjust to varying conditions. Note also that the conditioning wave may be received at a conditioning wave receiver (positioned at or near the signal receiver 204), such that the conditioning wave can carry other data, acting as a second data channel. In the case of counter-propagating conditioning channel, the conditioning channel can carry the feedback information signal.

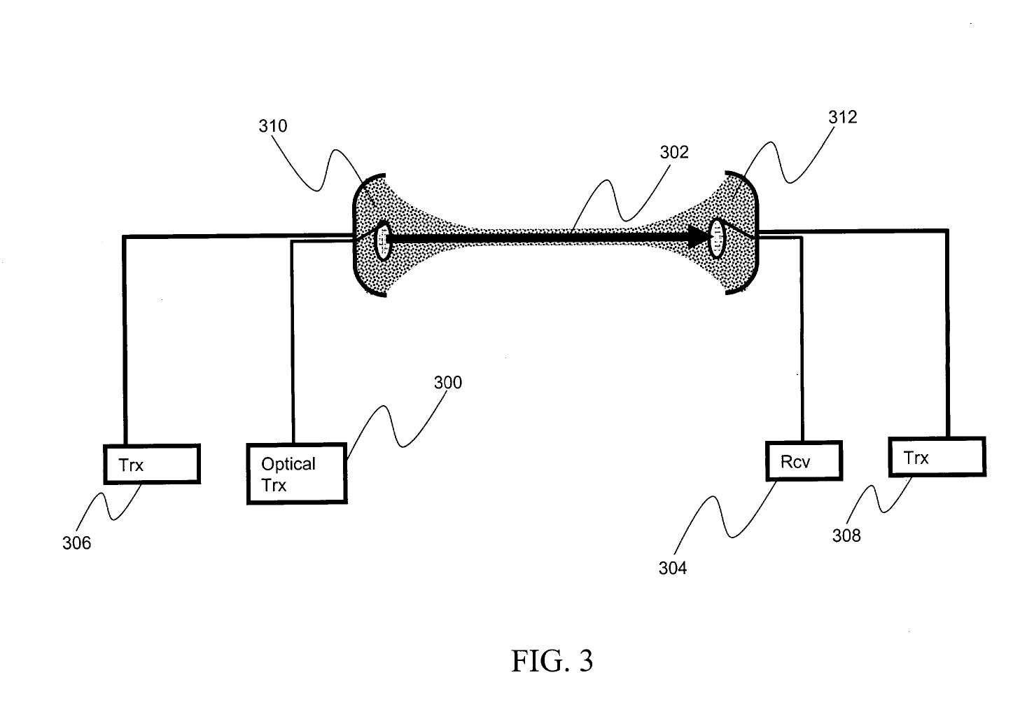

A bi-directional version of the present invention is depicted in FIG. 3, wherein a data transmitter 300 transmits a signal (data) wave 302 to be received by a data receiver 304. In this case, conditioning wave transmitters 306 and 308 transmit conditioning waves 310 and 312 in both co- and counter-propagation directions with respect to the signal wave 302. The conditioning waves 310 and 312 may be of the same wavelength or of different wavelengths, depending on the goals of a particular system. This scheme generally offers a more uniform conditioning/heating along the path, and helps to ensure a higher degree of free-space optical wireless link availability under heavy fog weather.

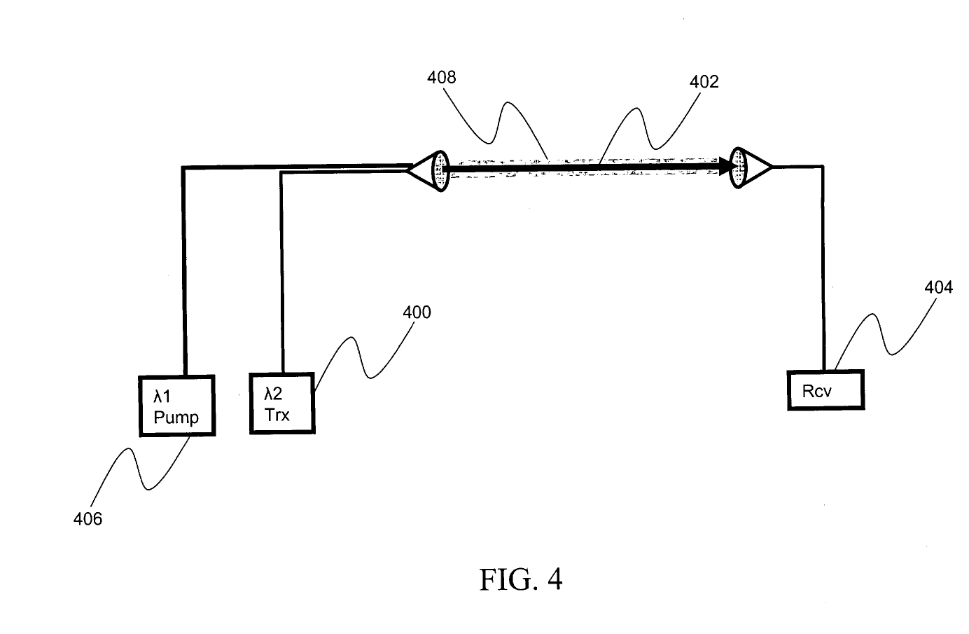

Another example of the present invention is shown in FIG. 4, where a transmitter 400 transmits a signal wave 402 to be received by a receiver 404. In this case, the conditioning wave transmitter 406 generates a conditioning wave 408 in the form of a laser of a second wavelength (as opposed to the wavelength of the signal wave 402), selected for its high degree of water absorption. A non-limiting example is using a 1480 nm laser as the channel heating wavelength (in the oxygen-hydrogen absorption band) for the conditioning wave 408, and a conventional fiber-optic communication wavelength of 1300 or 1550 nm for the signal wave 402. The propagation of the conditioning wave 408 with respect to the signal wave 402 could be co- or counter-propagation or bi-directional.

Co-axially-propagated links presented herein could be used as “hybrid,” all-weather complementary wireless links. Thus, for example, a conditioning wave operating at millimeter wave frequencies could be used not only to condition the channel for the laser link, but also to provide a parallel communicating channel as a bypass communicating channel to accommodate data rates switched from the free-space optical link. The dual-functionality of the hybrid link would allow the flexibility of selective traffic routing to alternate end-users for geographical diversity, multi-service, and multi-cast/broadcast operation.

A few example design parameters that can aid in tailoring the present invention to a particular application include:

Selecting the conditioning wave for an optimum heating characteristic, absorption, heat gradient, and convection current.

Determining the conditioning wave's wavelength and power as a function of water droplet size and fog density, and channel physical diameter volume.

Selecting the microwave antenna shape, number of elements (in the case of antenna arrays), and the focusing characteristics for uniform heating but minimum power utilization.

Determining the minimum and maximum demanded channel quality requirements to select the proper equipment for the combined conditioning/data architecture (whether co-, counter-, or bi-directional).

Determining the channel thermodynamic characteristics as well as the equipment characteristics in order to determine whether to use a pulsating or continuous format for the conditioning wave.

Due to the presence of multiple wavelengths along the signal wave path (e.g., channel-forming wavelengths and data-communication wavelengths), the detectors need to be frequency-selective. The selectivity and the impact of the presence of the other wavelengths need to be considered during system design.

Optimization of high-speed wireless network availability in all-weather and diverse atmospheric conditions should be sought for the link fail/safe operation and path protection.

What is claimed is:

1. An apparatus for conditioning a wireless data communication path for the transmission of a signal wave, the apparatus comprising a conditioning wave transmitter positioned to transmit a conditioning wave along at least a portion of the wireless data communication path and to form a conditioning envelope thereabout, with the conditioning wave having a wavelength selected to remove undesirable particles from the wireless data communication path.

2. The apparatus of claim 1, wherein the signal wave is transmitted in a direction, and wherein the conditioning wave transmitter is positioned to transmit the conditioning wave in a manner selected from a group consisting of co-directionally with respect to the signal wave; counter-directionally with respect to the signal wave; and both co-directionally and counter-directionally with respect to the signal wave.

3. The apparatus of claim 1, wherein the conditioning wave is pulsed.

4. The apparatus of claim 1, wherein the conditioning wave is pulsed in a pattern selected from a group consisting of evenly spaced pulses and randomly spaced pulses.

5. The apparatus of claim 1, wherein the conditioning wave has a wavelength selected from a group consisting of radio-frequencies and optical wavelengths.

6. The apparatus of claim 5, wherein the conditioning wave is selected from a group consisting of millimeter waves, microwave waves, and optical signals.

7. The apparatus of claim 1, further comprising a feedback channel for dynamically adjusting the transmission characteristics of the conditioning wave transmitter based on a received power level of the signal wave.

8. The apparatus of claim 7, wherein the feedback channel is selected from a group consisting of a wired feedback loop from a data receiver receiving the signal wave to the conditioning wave transmitter and a feedback signal transmitter positioned at the data receiver for transmitting a gage signal from the data receiver to the conditioning wave transmitter, with the feedback signal having a wavelength having a degradation characteristic correlated with that of the signal wave to facilitate adjustments to the conditioning wave effectiveness of the transmitter to improve signal wave transmission conditioning.

9. The apparatus of claim 1, further comprising a conditioning wave receiver, and wherein the conditioning wave transmitter transmits a conditioning wave that is received by the conditioning wave receiver, where the conditioning wave includes data, whereby the conditioning wave transmitter and the conditioning wave receiver act as a second additional data channel.

10. The apparatus of claim 1, wherein the conditioning wave transmitter rotates the conditioning wave about an axis formed by the signal wave to form a spiral conditioning envelope thereabout.

11. A method for conditioning a wireless data communication path for the transmission of a signal wave, the method comprising a step of:
transmitting a conditioning wave along at least a portion of the wireless data communication path to form a conditioning envelope thereabout, with the conditioning wave having a wavelength selected to remove undesirable particles from the wireless data communication path.

12. The method of claim 11, wherein the signal wave is transmitted in a direction, and wherein in the transmitting step, the transmitter transmits the conditioning wave in a direction, with the direction of the conditioning wave being selected from group consisting of co-directional transmission with respect to the direction of the signal wave; counter-directional transmission with respect to the direction of the signal wave; and both co- and counter-directional with respect to the direction of the signal wave.

13. The method of claim 11, wherein in the transmitting step, the conditioning wave is pulsed.

14. The method of claim 11, wherein in the transmitting step, the conditioning wave is pulsed in a pattern selected from a group consisting of evenly spaced pulses and randomly spaced pulses.

15. The method of claim 11, wherein in the transmitting step, the conditioning wave has a wavelength selected from a group consisting of radio-frequencies and optical wavelengths.

16. The method of claim 15, wherein in the transmitting step, the conditioning wave is selected from a group consisting of millimeter waves, microwaves, and optical signals.

17. The method of claim 11, further comprising a step of dynamically adjusting transmission characteristics of the conditioning wave transmitter based on a received power level of the signal wave.

18. The method of claim 17, wherein the step of dynamically adjusting is performed using a feedback channel selected from a group consisting of a wired feedback loop from a data receiver receiving the signal wave to the conditioning wave transmitter and a feedback signal transmitter positioned at the data receiver for transmitting a gage signal from the data receiver to the conditioning wave transmitter, with the feedback signal having a wavelength having a degradation characteristic correlated with that of the signal wave to facilitate adjustments to the conditioning wave effectiveness of the transmitter to improve signal wave transmission conditioning.

19. The method of claim 11, wherein in the transmitting step, the conditioning wave carries data to be received by a conditioning wave receiver, thereby providing a second additional data channel.

20. The method of claim 11, further comprising a step of rotating the conditioning wave about an axis formed by the signal wave to form a spiral conditioning envelope thereabout.
